(19) United States
(12) Patent Application Publication
(10) Pub. No.: US 2007/0223414 A1
(43) Pub. Date: Sep. 27, 2007

(54) SYSTEM AND METHOD FOR MULTI-SOURCE DATA COMMUNICATIONS

(75) Inventor: Robert G. Mechaley, Kirkland, WA (US)

Correspondence Address: DAVIS WRIGHT TREMAINE, LLP, 1201 Third Avenue, Suite 2200, SEATTLE, WA, 98101-3045, US

(73) Assignee: EAGLE RIVER HOLDINGS LLC, Kirkland, WA (US)

(21) Appl. No.: 11/688,422

(22) Filed: Mar. 20, 2007

Related U.S. Application Data
(60) Provisional application No. 60/785,122, filed on Mar. 23, 2006.

(51) Int. Cl. H04B 7/212

(52) U.S. Cl. 370/324

(57) ABSTRACT

A system and method for multi-source data communications includes a receiver configured to receive a first data stream from a first data source, such as a satellite. Associated with the first data stream is an instruction to the receiver that causes the receiver to receive a second data stream from a second data source. The second data source may be a different satellite beam from the first satellite, a second satellite, or a terrestrial source. A receiver processes the first and second data streams to produce an output. The second data stream may be inserted into the first data stream at a predetermined point. Alternatively, the first and second data streams may be processed concurrently and combined by an output device. The first and second data streams may be identical data types, or differing data types.

### FIELD OF THE INVENTION

The present invention is directed generally to communications, and, more particularly, to a system and method for multi-source data communications in a data communications network.

### DESCRIPTION OF THE RELATED ART

The use of satellites for commercial broadcasting is well known. Early satellites often provided a useful communication link for a broadcast network. For example, a network television program originating in New York could be relayed via satellite to the network affiliate in, by way of example, Seattle. However, the viewer did not receive the satellite signal directly, but used conventional broadcast or cable technology to receive the broadcast signal from the local network affiliate.

More recently, direct satellite broadcasts became readily available to the consumer. In this implementation, the viewer has a satellite antenna and receiver that allows direct reception of signals from the broadcast satellite.

While direct satellite broadcasting for television has become commonplace, direct broadcasting of audio signals is relatively new. Subscriber radio is but one example of direct broadcasting of radio signals. From a technological perspective, the data stream broadcast from the satellite is typically a digital data stream that may be audio only, video only, or multimedia content (e.g., video and audio).

Unfortunately, while satellite receivers allow the reception of data content from far-away sources, it does not permit the reception of local data sources. For example, satellite TV permits the reception of multiple network feeds from many different networks, but does not enable the user to receive television signals from the local network affiliate. Typically, the user must also subscribe to cable or use a conventional television antenna to receive the broadcast signals from local network affiliates unless the local network affiliate's signal is transmitted to the satellite for subsequent retransmission to the user's satellite receiver. Similarly, cable or conventional television antennas are required to receive television signals from local independent stations that have no network affiliations or satellite broadcast capabilities.

Similarly, while the satellite broadcasting system may simulcast the satellite signal terrestrially to improve signal strength reception of satellite radio broadcasts does not permit the user to receive local broadcasts. Some additional means, such as cable or conventional broadcast antennas and receivers are required for local reception.

Therefore, it can be appreciated that there is a significant need for a system and method that allows the combination of multiple data sources. The present invention provides this, and other advantages, as will be apparent from the following detailed description and accompanying figures.

### BRIEF DESCRIPTION OF THE SEVERAL VIEWS OF THE DRAWING(S)

FIG. 1 is a diagram illustrating a communication network constructed in accordance with the present description.

FIG. 2 is a diagram representing multiple coverage beams from the satellite portion of the system of FIG. 1.

FIG. 3 is a function block diagram of a user terminal used in conjunction with the system of FIG. 1.

FIG. 4 is a flowchart illustrating the operation of the receiver of FIG. 2.

FIG. 5 is a sample data frame illustrating the reception of data from multiple sources.

### DETAILED DESCRIPTION OF THE INVENTION

The present disclosure is directed to a telecommunication system that typically includes both satellite and terrestrial components. As will be described in greater detail below, data included in a data stream broadcast from a satellite will instruct a user terminal to receive an additional data stream from a second source wherein the second data stream will be combined with the first data stream.

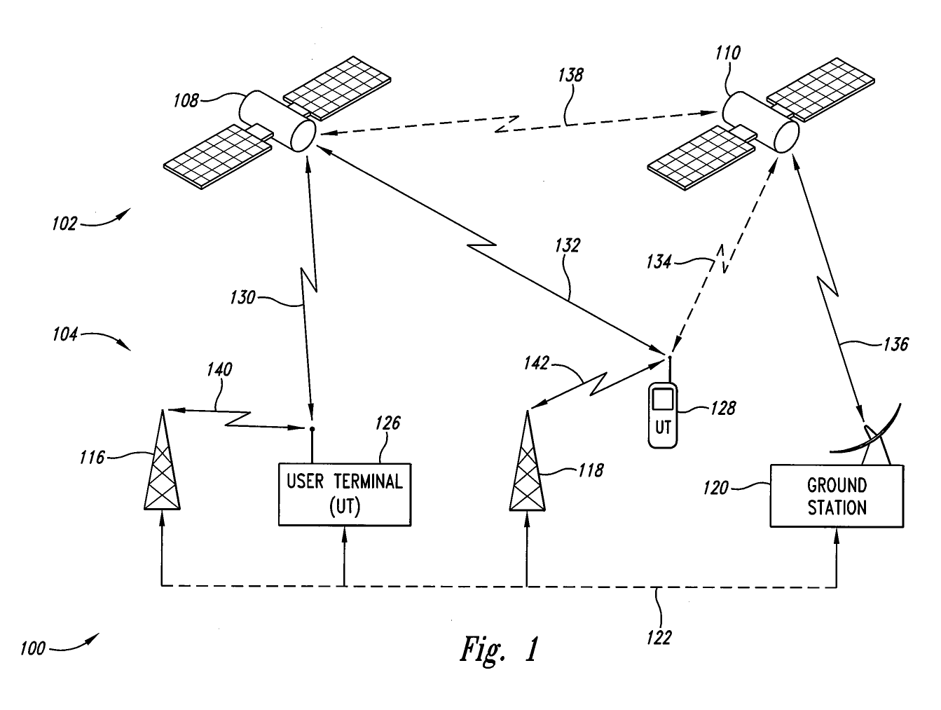

FIG. 1 is a diagram illustrating sample components of a system 100 constructed and operating in accordance with the teachings contained herein. The system 100 has a satellite portion 102 and a terrestrial portion 104. FIG. 1 illustrates a satellite 108 and a satellite 110 in earth orbit. Those skilled in the art will appreciate that an actual implementation may typically include a larger number of satellites. The satellites 108-110 may be in any known satellite configuration, such as geosynchronous or geo-stationary orbits, medium earth orbit (MEO), low earth orbit (LEO), or a combination thereof.

The satellites 108-110 also receive control signals from a control station (not shown). The control station provides signals that maintain the proper attitude and orbital position of the satellites within the satellite portion 102 of the system 100. Control of the attitude and orbit of satellites is known in the art and need not be described herein.

General operation of the satellite portion 102 is known to those skilled in the art and need not be described in greater detail herein except as to the instructions regarding a secondary data source, which will be discussed in greater detail.

FIG. 1 also illustrates a user terminal (UT) 126 and a UT 128. The UT may be in a fixed location, such as the end user's home, or implemented as a mobile device, such as, by way of example, an automobile receiver. In the illustration of FIG. 1, the UT 126 may be a television receiver (either fixed or portable) while the UT 128 illustrates an audio device (either fixed or portable). Those skilled in the art will appreciate that the description contained herein is equally applicable to video data stream, audio data stream, or multimedia data stream. In a typical implementation, the satellite portion 102 of the system 100 transmits data packets that are received and processed by the UT (e.g., the UT 126) to provide the broadcast signal. In the case of a television signal, both video and audio data streams are provided in the data packets. For purposes of the present description, the received data can simply be described as a data stream.

The terrestrial portion 104 of the system 100 comprises a broadcast station 116 and a broadcast station 118. FIG. 1 also illustrates a ground station 120. Various components of the terrestrial portion 104 of the system 100 may be coupled together via an optional communication link 122. In the example of FIG. 1, the broadcast stations 116-118, the ground station 120, and the UT 126 are coupled together by an optional communication link 122. The communication link 122 may be a high-speed hard-wired data link, microwave link, or the like. In one embodiment, the communication link 122 may be part of a wide area network (WAN), such as the Internet. The system 100 is not limited by the specific form of the communication link 122.

In an alternative embodiment, the system 100 is implemented without the communication link 122. This may be a typical implementation when the broadcast station 116 and the broadcast station 118 are not affiliated with each other. For example, the broadcast station 116 may be a network affiliate while the broadcast station 118 may be an independent station or affiliated with a different network. Similarly, the ground station 120 may be associated with either broadcast station 116, the broadcast station 118, or part of a separate affiliation. For example, so-called “superstations” are local television stations that beam their signals to a satellite that broadcast their signals for open reception by any satellite receiver.

As will be described in greater detail, the UT (e.g., the UT 126) receives a first data stream from a first data source, such as the satellite 108. Contained within the data stream received from the satellite 108 are instructions that cause the UT 126 to receive a second data stream from a second data source, such as the broadcast station 116. The first and second data streams are combined in the UT 126 to produce the desired final signal.

FIG. 1 also diagrammatically illustrates communication links between various system components. For example, there is a wireless communication link 130 between the satellite 108 and the UT 126. A similar wireless communication link 132 is illustrated between the satellite 108 and the UT 128. FIG. 1 also illustrates communication link 134 between the satellite 110 and the UT 128. This serves to illustrate a typical scenario in which a particular user terminal is capable of receiving communications from more than one satellite. In this example, the UT 128 is capable of communicating with the satellite 108 via the communication link 132 and/or communicating with the satellite 110 via the communication link 134.

FIG. 1 also illustrates wireless communication link 136 between the satellite 110 and the ground station 120. As previously discussed, signals used to control the position and attitude of the satellites in the satellite portion 102 may be communicated from the ground station 120 via the communication link 136. The communication link 136 may also be used to represent an uplink from the ground station 120 to the satellite 110. For example, the ground station 120 may be a television station that broadcasts via the satellite portion 102 of the system 100. In this embodiment, the communication link 136 serves as the satellite uplink.

The satellite portion 102 may also include an intersatellite communication link 138 between the satellite 108 and the satellite 110. Other intersatellite communication links (not shown) may exist between other satellites (not shown) in the satellite portion 102 of the system 100. The intersatellite communication link 138 is conventionally used to relay data with the individual satellites essentially serving as nodes on a communication network. For example, a signal may be provided by the ground station as an uplink to the satellite 110 using the communication link 136. The satellite 110 in turn relays the data to the satellite 108 via the communication link 138. The satellite 108 provides a downlink to the UT 126 via the communication link 130 and to the UT 128 via the communication link 132.

The intersatellite communication link 138 may also be used to relay satellite control signals between satellites to adjust the position and attitude of the satellites within the satellite portion 102 of the system 100.

In addition to the communication links between the satellite portion 102 of the system 100 and the terrestrial portion 104, FIG. 1 illustrates wireless communication links between various components of the terrestrial portion 104. For example, FIG. 1 illustrates a communication link 140 between the broadcast station 116 and the user terminal 126. FIG. 1 also illustrates a communication link 142 between the broadcast station 118 and the UT 128. Those skilled in the art will appreciate that other communication links (not shown) may exist between the broadcast stations 116-118 and other user terminals (not shown). The system 100 may also include communication links between other broadcast stations (not shown) and the user terminals 126-128 or communication links to other terminals (not shown). Thus, the communication links 130-142 are illustrated in FIG. 1 simply to illustrate a simple network topology.

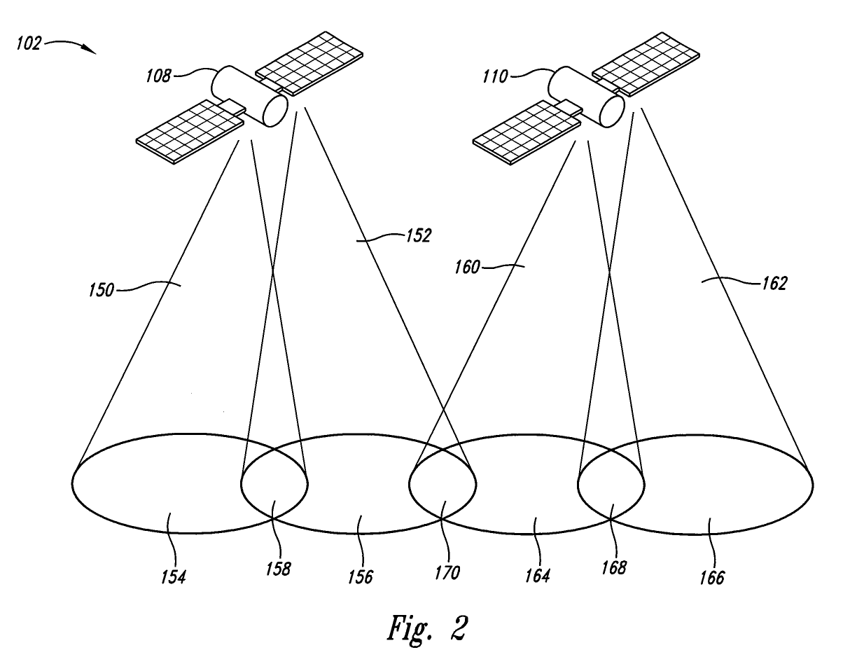

FIG. 1 diagrammatically illustrates simple communication links. However, those skilled in the art will appreciate that a typical satellite provides at least one zone or area of coverage. For example, a broadcast satellite in a geosynchronous or geostationary orbit may have an area of coverage that includes the entire continental United States. Other satellites may include multiple beams to provide multiple areas of coverage. FIG. 2 provides an example of such an implementation. Although a typical satellite has a large number of beams, FIG. 2 illustrates the satellite 108 having a beam 150 and a beam 152 to provide areas of coverage 154 and 156, respectively. In a typical implementation, the beams 150 and 152 provide an overwrapping area of coverage 158. Similarly, FIG. 2 illustrates the satellite 110 as having a beam 160 and a 162 to provide areas of coverage 164 and 166, respectively. The beams 160-162 also overlap to provide an overlapping area of coverage 168. FIG. 2 further illustrates an overlapping area of coverage 170 between the beams 152 and 160 from the satellites 108-110, respectively. Those skilled in the art will appreciate that a typical satellite has more than two beams and additional multiple overlapping areas of coverage. However, for the sake of clarity, FIG. 2 illustrates only two beams from each of the satellites 108-110, respectively.

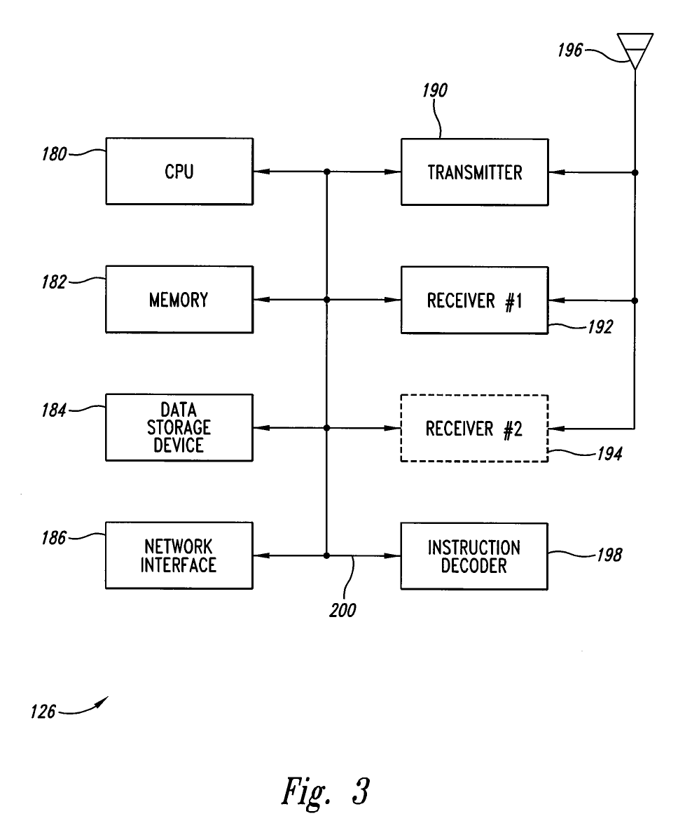

FIG. 3 is a functional block diagram, both a UT (e.g., the UT 126). For the sake of clarity, certain conventional components, such as a video display, audio speakers, power supply, and the like, are omitted from FIG. 3. The operation of these components is well known and need not be described herein.

The functional block diagram of FIG. 3 includes a central processing unit (CPU) 180 and a memory 182. In general, the CPU 180 receives instructions and data from the memory 182 and executes those instructions. The CPU 180 may be implemented as a conventional microprocessor, microcontroller, programmable gate array (PGA), discrete circuit, application-specific integrated circuit (ASIC), or the like. The system 100 is not limited by the specific implementation of the CPU 180. Similarly, the memory 182 may be implemented by a variety of known technologies. The memory 182 may include dynamic memory, static memory, programmable memory, or the like. The system 100 is not limited by any specific implementation of the memory 182.

The block diagram of FIG. 3 also illustrates a data storage device 184 and a network interface 186. The data storage device 184 may be implemented using a variety of known technologies. For example, the data storage device may include one or more known components such as a magnetic disk drive, optical drive, tape, or the like. The system 100 is not limited by any specific implementation of the data storage device 184. As will be described in greater detail below, the data storage device 184 may be used to temporarily store incoming data packets to permit the appropriate combination of multiple data streams from multiple data sources.

The network interface 186 is a conventional network interface whose specific implementation may vary. For example, the network interface 186 may be implemented as a universal serial bus (USB) interface, Ethernet interface, firewire interface, Bluetooth interface, or the like. The system 100 is not limited by the specific form of the network interface 186. As will be described in greater detail below, the network interface 186 may provide a connection to a second data source for use by the UT 126.

FIG. 3 also illustrates a transmitter 140. As will be described in greater detail below, the transmitter 140 may be used by the UT 126 to transmit a request to a second data source (e.g., the broadcast station 116) to request a second additional data stream. Alternatively, the request for the additional data stream may be transmitted via the network interface 186.

FIG. 3 also illustrates a first receiver 192 and an optional second receiver 194. In one embodiment, the first receiver 192 is configured to receive the first data stream from a first data source (e.g., the satellite 108). Upon receipt of instructions to receive the second data stream from the second data source (e.g., the broadcast station 116), the first receiver 192 may quickly retune to the appropriate frequency used by the broadcast station 116 to receive the second data stream. The second data stream may be temporarily stored in the data storage device 184 to await processing and insertion into the first data stream. Upon completion of receipt of the second data stream from the second data source, the first receiver 192 may retune to the frequency for the first data source (e.g., the satellite 108) and continue to receive the first data stream.

Alternatively, if the UT 126 includes the second receiver 194, the first receiver 192 may stay tuned to the frequency of the first data source while the second receiver 194 is tuned to the frequency of the second data source (e.g., the broadcast station 116). Those skilled in the art will appreciate that additional receivers may be included in the UT to receive additional data streams from other data sources. Those skilled in the art will also appreciate that a transmitter 190, receiver 192, and optional receiver 194 may have common circuitry and be implemented as a transceiver. The transmitter 190 and receivers 192-194 are coupled to an antenna 196. The antenna 196 may be implemented using a variety of known designs, such as omni-directional dipole antennas, directional antennas, phased array antennas, and the like. The system 100 is not limited by the specific implementation of the antenna 196.

The UT 126 also includes an instruction decoder 198. As will be described in greater detail below, the first data stream includes instructions for the UT 126 to receive a second data stream from a second data source. The instruction decoder 198 is configured to detect the instructions in the first data stream and to take appropriate action. This may include retuning the first receiver 192 to the operating frequency of the second data source, or tuning the second receiver 194 to the operating frequency of the second data source. Those skilled in the art will appreciate that the instruction decoder 198 may be implemented by the CPU 180 executing instructions from the memory 182. However, the instruction decoder 198 is illustrated as a separate block in the functional block diagram of FIG. 3 because it performs a separate function.

The various components illustrated in FIG. 3 are coupled together by a bus system 200. The bus system 150 may include a power bus, address bus, control bus, data bus, and the like. For the sake of convenience, these various buses are illustrated in FIG. 2 as the bus system 200.

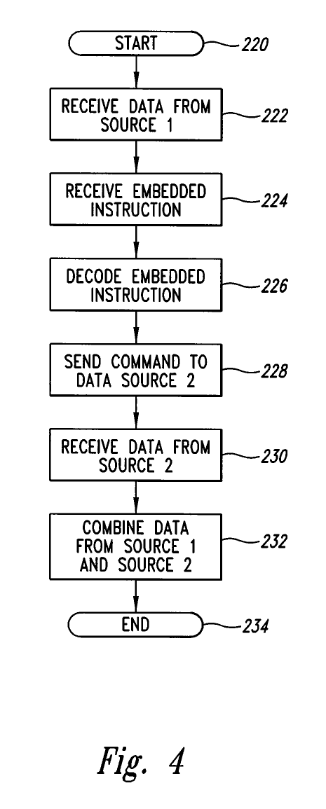

FIG. 4 is a flowchart illustrating the operation of the system 100 in an exemplary embodiment. For purposes of discussion, assume that the receiver is the UT 126. However, the process is equally applicable to the receiver 128 receiving audio data from multiple data sources. At a start 220, the first receiver 192 is tuned to a frequency that allows reception of a first data stream from a first data source. In an exemplary embodiment, the first or primary data source is the satellite 108. At step 222, the first receiver 192 receives the first data stream from the first data source. The first data stream includes instructions for the UT to receive a second data stream. The first data stream may include, contain, or have imbedded, information that instructs the UT 126 to receive a second data stream from a second data source. At step 224, the instruction decoder 198 (see FIG. 3) receives the embedded instruction and, at step 226, the instruction decoder 198 decodes the embedded instruction. In one embodiment, the special instruction may take the form of a conventional data packet that has a unique packet identifier. In this embodiment, the instruction decoder 198 detects the unique data in the packet header and takes appropriate action to set up reception of the second data stream from the second data source.

At step 228, the UT (e.g., the UT 126) transmits a command to the second data source requesting delivery of the second data stream to the UT. As previously discussed, the command may be transmitted to the second data source via a wireless communication link, such as the communication link 140 (see FIG. 1) or via the communication link 122. The second data source may be in the satellite portion 102 or the terrestrial portion 104 of the system 100. For example, if the first data source is the satellite 108, the second data source may be a beam from the satellite 110 if, by way of example, the UT is located in the overlapping area of coverage 170 (see FIG. 2). Alternatively, the second data source may be a second beam from the same satellite as the first data source. For example, the satellite 108 may provide the first data source in the beam 150 while the second data source may be from the beam 152 if the UT is in the overlapping area of coverage 158. In yet another alternative embodiment, the second data source may be a second frequency or channel of the same satellite as the first data source.

If the second data source is part of the terrestrial portion 104 of the system 100, it may also be provided by multiple data sources. For example, the broadcast station 116 (see FIG. 1) may act as the second data source for the UT 126. The UT 126 may also be capable of receiving data from the broadcast station 118 via a different communication link (not shown). In this case, the broadcast station 118 serves as the second data source. In yet another alternative embodiment, a separate broadcast station or network element may serve as the second data source via the communication link 122 (see FIG. 1). Thus, the system 100 is not limited by the specific type, form, or location of the second data source.

In step 230, the UT receives data from the second data source. The second data stream may be provided in a variety of formats. In one example, the first and second data streams may both be audio data streams, video data streams, or a combination of video and audio, such as is common in a conventional television broadcast. In an alternative embodiment, the first data stream may be a video data stream (or a combination of video and audio) while the second data stream may be an audio data stream. The first and/or second data stream may also be image data, using, by way of example, a JPEG data format. Similarly, other industry formats, such as a GIF, MPEG, or the like may also be used for image data, video data, audio data, or the like. Those skilled in the art will appreciate that the system 100 is not limited by the particular form of either the first or second data stream.

Furthermore, it should be appreciated that the subject matter of the first and second data streams may be related or unrelated. In an example of related subject matter, the first data stream may be a video/audio presentation on a particular subject while the second data stream may provide, by way of example, additional images of related subject matter. In an example of unrelated subject matter, the first data source may provide video/audio while the second data stream may contain, by way of example, a news alert that is unrelated to the subject matter of the first data stream.

Returning again to FIG. 4, the UT combines the data from the first data source and second data source in step 232. The term “combined” should not be viewed as a limitation in the manner in which the first and second data streams are processed. That is, the first and second data streams need not be combined to form some third integrated data stream. For example, the first data stream may be a combined video/audio data stream, such as a conventional television signal. The second data source may be a video overlay, such as an emergency weather broadcast signal that is displayed on the end user television to warn of dangerous weather conditions (e.g., a tornado warning). The second data stream may also be a video overlay to provide breaking news or other relevant information provided by the second data source. In these embodiments, the data packets from the first and second data streams need not be combined into some single data stream, but may be processed separately and provided to the television.

In yet another alternative embodiment, the second data stream may be an audio data stream played on top of the normal audio from the television broadcast. The second data source may provide similar emergency broadcast information or other data. The second data stream may be immediately inserted into the first data stream at the time of reception. That is, the second data stream may be inserted at the point where the embedded instruction is received (see step 224). Alternatively, the second data stream may be inserted at some other point in the first data stream or a different data stream. In this embodiment, the second data stream may be buffered for some small period of time and then inserted. In yet another alternative embodiment, the second data stream may be stored in the data storage device 184 (see FIG. 3) for later insertion into the first data stream or another data stream. The point of insertion may be an absolute point specified in the embedded instruction or in the received second data stream or at a relative time specified by the embedded instruction or the data received in the second data stream. Finally, the first and second data streams may be processed independently. For example, the first data stream may be a combination of audio and video, such as a conventional television broadcast while the second data stream is an audio data stream that is decoded by the UT and delivered to an audio input of a television monitor. Thus, the first and second data streams may be processed independently or jointly in a variety of different processes. Thus, the system 100 is not limited by the form of the first and/or second data streams or the manner in which the data streams are processed and subsequently utilized.

The process ends at 234 with the UT having received first and second data streams and processed the first and second data streams for subsequent utilization. Those skilled in the art will appreciate that this technique could be extended to more than two data streams. For example, the first data stream may contain embedded instructions for the UT to receive second and third data streams from second and third data sources, respectively. This process may be extended further. In one embodiment, the first receiver 192 (see FIG. 3) is retuned to the second and third data sources at appropriate times. Alternatively, the optional second receiver 194 may be returned to receive the second data stream and the third data stream at appropriate times. In yet another alternative embodiment, the UT may contain additional receivers to allow independent reception of data from multiple data sources.

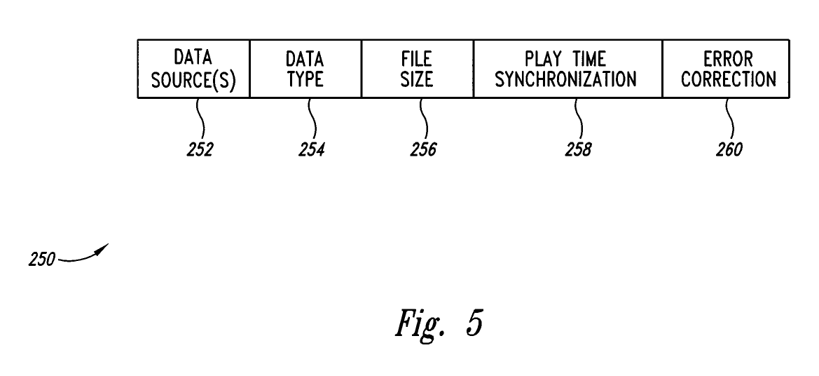

FIG. 5 is a sample data header 250 illustrating the embedded instructions received in the first data stream. A data source header 252 identifies the second data source. This identification may include, by way of example, a receiver frequency, a station identification, a uniform resource locator (URL), or the like.

A receiver frequency may be used, by way of example, for an emergency broadcast. In this example, the UT may immediately return its receiver (either the first receiver 192 or the optional second receiver 194 of FIG. 3) to the identified radio frequency and thereby receive the second data stream.

A station identification data source may indicate a network affiliation. For example, the first data source may be a national transmission from a particular network. The station identification may instruct the UT to tune to a frequency associated with the local affiliate of the particular network. In this embodiment, the data storage device 184 may contain a list of frequencies for local affiliates. This would enable the UT to be located in different geographical regions and tune the receiver to the frequency for the appropriate local network affiliate.

A URL data source header may cause the UT to access a wide area network, such as the internet, using the network interface 186 (see FIG. 3). The request of data resources utilizing a URL is well known in the art and need not be described in greater detail herein.

The data header 250 may also include a data type header portion 254 that identifies the particular type of data in the second data stream. As previously noted, the second data stream may contain audio data, video data, a combination (e.g., a television signal), image data, or the like. The data type header portion 254 may be used by the UT to determine the appropriate data processing capabilities required to receive the second data stream. For example, if the data type header portion 254 indicates that the second data stream contains MPEG audio data, the UT may access the appropriate CODEC to process the MPEG data from the second data source. Other data types may be processed in a similar fashion.

A file size data header portion 256 provides the UT with an indication of the expected file size. It should be noted that in some cases, the second data stream may be an ongoing data stream whose size is indeterminant. The file size header portion 256 may contain an indication that the file size is open-ended.

The data header 250 also includes a playtime synchronization data header portion 258. The playtime synchronization data header portion 258 provides the UT with instructions as to point in time where the second data stream will be played. As previously noted, the second data stream may be inserted into the first data stream at a specific time. This may be the point in time where the embedded instruction was received in the first data stream or some other absolute point in time. Alternatively, the playtime synchronization data header portion 258 may include a relative point in time, such as upon completion of a certain portion of the first data stream. Data packet identifiers or other identifiers may be used to determine the point where the second data stream should be inserted, combined, or processed, into the first data stream. Specific synchronization techniques are known in the art and need not be described in greater detail herein.

Those skilled in the art will appreciate that the playtime synchronization data header portion 258 indicates the point in time at which the second data stream will be inserted into, combined with, or otherwise integrated with the first data stream. In some embodiments, the raw data may be processed on the fly for insertion into the first data stream. In other embodiments, the second data stream may be stored in the data storage device 184 (see FIG. 3) in its received form and processed on the fly at the subsequent point in time where the second data stream will be combined with the first data stream. In yet another alternative embodiment, the second data stream may be processed and the processed data stored in the data storage device 184 for subsequent combination with the first data stream. The specific data processing techniques are known to those skilled in the art and need not be described in greater detail herein.

The data header 250 may also contain an error correction data header portion 260. This may include both error detection and/or error correction. A number of known techniques for error detection and/or correction are known in the art and may be readily implemented in the system 100. If an error is detected, the UT may request retransmission of the data packet containing the data header 250. Alternatively, the error may be detected and corrected without requiring the retransmission of the data header 250.

Thus, the system 100 enables the reception and combination of multiple data streams from multiple data sources. The technique permits the combination of multiple types of data from multiple data sources and permits the combination of the data sources at specified points in time.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A system comprising:
a receiving station configured to receive a first data stream from a first data source, the first data source being a first satellite configured to provide the first data stream;
an instruction message from the first data source to instruct the receiving station to receive a second data stream from a second data source different from the first data source; and
a processor associated with the receiving station configured to combine the second data stream with the first data stream.

2. The system of claim 1 wherein the second data source is a second satellite.

3. The system of claim 1 wherein the first data source is a first beam of the first satellite and the second data source is a second satellite beam of the first satellite.

4. The system of claim 1 wherein the first data source is a first channel of the first satellite and the second data source is a second channel of the first satellite.

5. The system of claim 1 wherein the second data source is a terrestrial transmitted signal.

6. The system of claim 1 wherein the second data source is a terrestrial computer network.

7. The system of claim 1 wherein the processor is configured to combine the second data stream with the first data stream by inserting the second data stream into the first data stream at a predetermined point.

8. The system of claim 7 wherein the predetermined point is a predetermined point in time.

9. The system of claim 7 wherein the predetermined point is a predetermined point in the first data stream.

10. The system of claim 1 wherein the processor is configured to combine the second data stream with the first data stream by concurrently processing the first data stream and the second data stream and combining first and second processed data streams at a data output device.

11. The system of claim 1, further comprising a storage device wherein the processor is configured to process the second data stream and store the processed second data stream in the storage device for combination with the first data stream at a subsequent time.

12. The system of claim 1 wherein the receiving station comprises a first receiver configured to receive the first data stream from the first data source, the first receiver being further operable to receive the second data stream from the second data source.

13. The system of claim 1 wherein the receiving station comprises a first receiver configured to receive the first data stream from the first data source and a second receiver configured to receive the second data stream from the second data source.

14. The system of claim 1, further comprising a receiving station transmitter configured to transmit a data request to the second data source to thereby initiate transmission of the second data stream.

15. The system of claim 1 wherein the instruction message is a portion of the first data stream.

16. A system comprising:
a receiving station configured to receive a first data stream from a first data source, the first data source being a first terrestrial transmitter configured to provide the first data stream;
an instruction message from the first data source to instruct the receiving station to receive a second data stream from a second data source different from the first data source; and
a processor associated with the receiving station configured to combine the second data stream with the first data stream.

17. The system of claim 16 wherein the second data source is a satellite.

18. The system of claim 16 wherein the second data source is a terrestrial computer network.

19. The system of claim 16 wherein the second data source is a second terrestrial transmitted signal.

20. The system of claim 19 wherein the first data source is a first beam of the first terrestrial transmitter and the second data source is a second beam of the first terrestrial transmitter.

21. The system of claim 19 wherein the first data source is a first channel of the first terrestrial transmitter and the second data source is a second channel of the first terrestrial transmitter.

22. The system of claim 19 wherein the first data source is a first beam of the first terrestrial transmitter and the second data source is a first beam of a second terrestrial transmitter.

23. The system of claim 16 wherein the receiving station comprises a first receiver configured to receive the first data stream from the first data source, the first receiver being further operable to receive the second data stream from the second data source.

24. The system of claim 16 wherein the receiving station comprises a first receiver configured to receive the first data stream from the first data source and a second receiver configured to receive the second data stream from the second data source.

25. The system of claim 16, further comprising a receiving station transmitter configured to transmit a data request to the second data source to thereby initiate transmission of the second data stream.

26. The system of claim 16 wherein the instruction message is a portion of the first data stream.

27. A system comprising:
a receiving station configured to receive a first data stream from a first data source configured to provide the first data stream;
an instruction message from the first data source to instruct the receiving station to receive a plurality of additional data streams from a plurality of additional data sources; and
a processor associated with the receiving station configured to combine the first data stream and the plurality of additional data streams.

28. The system of claim 27 wherein the first data source is a satellite.

29. The system of claim 28 wherein at least one of the plurality of additional data sources is a satellite.

30. The system of claim 27 wherein the first data source is a first beam of a first satellite and at least one of the plurality of additional data sources is a second beam of the first satellite.

31. The system of claim 27 wherein the first data source is a first channel of a first satellite and at least one of the plurality of additional data sources is a second channel of the first satellite.

32. The system of claim 27 wherein the first data source is a first beam of a first satellite and at least one of the plurality of additional data sources is a first beam of a second satellite.

33. The system of claim 27 wherein at least one of the plurality of additional data sources is a terrestrial computer network.

34. The system of claim 27 wherein at least one of the plurality of additional data sources is a terrestrial transmitted signal.

35. The system of claim 27 wherein the first data source is a terrestrial transmitted signal.

36. The system of claim 27 wherein the first data source is a first beam of a first terrestrial transmitter and wherein at least one of the plurality of additional data sources is a second beam of the first terrestrial transmitter.

37. The system of claim 27 wherein the first data source is a first channel of a first terrestrial transmitter and wherein at least one of the plurality of additional data sources is a second channel of the first terrestrial transmitter.

38. The system of claim 35 wherein at least one of the plurality of additional data sources is a satellite.

39. The system of 35 wherein at least one of the plurality of additional data sources is a terrestrial computer network.

40. The system of claim 27 wherein the instruction message is a portion of the first data stream.

41. A communications method comprising:
receiving a first data stream from a first data source;
detecting an instruction from the first data source to receive a second data stream from a second data source; and
combining the first data stream and the second data stream.

42. The method of claim 41 wherein the instruction is a portion of the first data stream.

43. The method of claim 41 wherein the first data source is a satellite.

44. The method of claim 43 wherein the second data source is a satellite.

45. The method of claim 43 wherein the second data source is a terrestrial computer network.

46. The method of claim 43 wherein the second data source is a is a terrestrial transmitted signal.

47. The method of claim 41 wherein the first data source is a terrestrial transmitted signal.

48. The method of claim 47 wherein the second data source is a satellite.

49. The method of claim 47 wherein the second data source is a terrestrial computer network.

50. The method of claim 47 wherein the second data source is a is a terrestrial transmitted signal.

51. A computer readable medium for communications comprising computer instructions that cause a processor to:
receive a first data stream from a first data source;
detect an instruction from the first data source to receive a second data stream from a second data source; and
combine the first data stream and the second data stream.

52. The computer readable medium of claim 51 wherein the instruction is a portion of the first data stream.

53. The computer readable medium of claim 51 wherein the first data source is a satellite.

54. The computer readable medium of claim 51 wherein the second data source is a satellite.

55. The computer readable medium of claim 51 wherein the second data source is a terrestrial computer network.

56. The computer readable medium of claim 51 wherein the second data source is a is a terrestrial transmitted signal.

57. The computer readable medium of claim 51 wherein the first data source is a terrestrial transmitted signal.

58. The computer readable medium of claim 57 wherein the second data source is a satellite.

59. The computer readable medium of claim 57 wherein the second data source is a terrestrial computer network.

60. The computer readable medium of claim 57 wherein the second data source is a is a terrestrial transmitted signal.
